(19) United States
(12) Patent Application Publication
(10) Pub. No.: US 2006/0075392 A1
(43) Pub. Date: Apr. 6, 2006

(54) System and method for reverse engineering of pattern string validation scripts

(75) Inventors: Scott R. Carrier, Apex, NC (US); Claudio Eduardo Scriptori de Souza, Apex, NC (US); Michael P. Etgen, Cary, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/958,609

(22) Filed: Oct. 5, 2004

(51) Int. Cl. G06F 9/45

(52) U.S. Cl. 717/136

(57) ABSTRACT

A system and method for reverse engineering of pattern string validation scripts is presented. A pattern engine receives an input string from a developer or a database, and generates a pattern string based upon the input string and strictness preferences. The strictness preferences identify how much to constrain generated pattern elements that are included in the pattern string. Once the pattern engine generates the pattern string, the pattern engine creates a user-friendly format string that is used by a developer to assess pattern string adjustments. The pattern engine may operate in a single mode or a multi-mode. In a single mode, the pattern engine uses a single input string to generate a pattern string. In a multi-mode, the pattern engine uses multiple input strings, typically from a database, to generate a pattern string.

### BACKGROUND OF THE INVENTION

1. Technical Field

The present invention relates in general to a system and method for reverse engineering of pattern string validation scripts. More particularly, the present invention relates to a system and method for using a valid input string to generate a pattern string that, in turn, is used to validate subsequent input strings.

2. Description of the Related Art

Electronic forms have become a commonplace on the Internet for search engines, polls, surveys, electronic commerce, and online applications. Most Internet user interaction is through some type of HTML-based form, which predates XML by half a decade. HTML-based forms, however, have technological limitations that include poor XML integration, dependency upon scripting, and limited accessibility features.

A new technology, xForms, combines XML and electronic forms. Since the primary purpose of an electronic form is to collect data, xForms includes “instance data,” which is an internal representation of the data that is mapped to familiar “form controls.” The instance data is based upon XML and is defined in terms of an internal tree representation and processing of XML. The xForms specification includes new form controls, or user interface components, that deal with interactive data entry and display. The form controls include text controls (e.g. “<input>”) and list controls (e.g. “<select>”) that correspond to particular fields that are included in a form.

When a software developer creates an xForm, the software developer defines valid input patterns for each field. For example, if a form asks for a zip code, the form may accept only numeric characters. A challenge found in generating a valid input pattern script to validate input strings is that it is a complex, tedious, and human error-prone task. In addition, a software developer must understand the xForm pattern syntax in order to write the pattern validation scripts.

What is needed, therefore, is a system and method to simplify the generation of pattern string validation scripts for use with xForm electronic forms.

### SUMMARY

It has been discovered that the aforementioned challenges are resolved by reverse engineering a valid input string, and creating a pattern string that is used to validate future input strings. A pattern engine receives strictness preferences from a developer, and generates a pattern string based upon the strictness preferences and an input string. The pattern engine may operate in a single mode or a multi-mode. In a single mode, the pattern engine uses a single input string to generate a pattern string. In a multi-mode, the pattern engine uses multiple input strings, typically from a database, to generate a pattern string. Once the pattern engine generates a pattern string, the pattern engine creates a user-friendly format string using the pattern string that the developer may analyze.

A developer provides strictness preferences to a pattern engine, whereby the strictness preferences determine what type of pattern element the pattern engine should generate for each valid input string element. For example, an input string of “abcd” may be converted to \w{4}, \w{0,4}, or \w*, whereby each of these pattern elements provide varying levels of flexibility in which to filter subsequent input strings. In a high strictness preference setting, the pattern engine may generate a pattern string that constricts the input for a set of word characters to match the same number of characters. In a low strictness preference setting, the pattern engine may generate a pattern string such that any number of word characters may be entered in a certain stanza of the pattern, or a range of characters that are based upon a valid input range. The pattern engine uses the strictness preferences in either single mode or multi-mode.

In single mode, the developer provides a valid input string to the pattern engine. The pattern engine uses the valid input string, along with the strictness preferences, in order to generate a pattern string and, in turn, uses the pattern string in order to generate a user-friendly format string. The user-friendly format string is in a format such that the developer is able to analyze the string and determine whether to make adjustments, such as making the corresponding pattern string more flexible to accept subsequent input strings. The developer may also test the generated pattern string by providing invalid input strings to the pattern engine and checking whether the pattern string rejects the invalid input strings. In addition, the developer may wish to validate the pattern string using a pattern validation test facility, which tests the pattern string using valid and invalid input strings.

In multi-mode, the pattern engine retrieves and queues valid input strings from a database. The pattern engine selects one of the input strings and generates a pattern string based upon the strictness preferences. Once a pattern string is generated, the pattern engine uses a different queued input string to validate the generated pattern string. Based upon the results, the pattern engine may modify the pattern string in order to accommodate varying types of input strings. The pattern engine may use each of the queued input strings in order to validate the generated pattern string, and then generate a user-friendly format string, which the developer may analyze.

In one embodiment, a user may wish to adjust the user-friendly format string without regenerating a user-friendly format string. In this embodiment, the user may modify a user-friendly format string appropriately. For example, a user may wish to combine the first two components of a user-friendly format string into one component (e.g. “8 word characters” and “2 digits”). In this example, the user may change the first two components into “10 alphanumeric characters” or “alphanumeric characters*” to accept any number of alphanumeric characters. Thus, the user, without having to understand the underlying pattern syntax, is able to easily modify a user-friendly format string in order to arrive at a pattern string that meets the user's requirements.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a pattern script reverse engineering engine generating a pattern string and a user-friendly format string using a valid input string;

FIG. 2 is a high-level flowchart showing steps taken in using strictness preferences to tailor a pattern string and a user-friendly format string;

FIG. 3 is a flowchart showing steps taken in receiving an input string from a user and generating a pattern string based upon particular strictness preferences;

FIG. 4 is a flowchart showing steps taken in receiving a plurality of input strings from a database and customizing a pattern string based upon one or more valid input strings;

FIG. 5 is a diagram flow showing various sequences of events in using an input string to generate a user-friendly format string; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

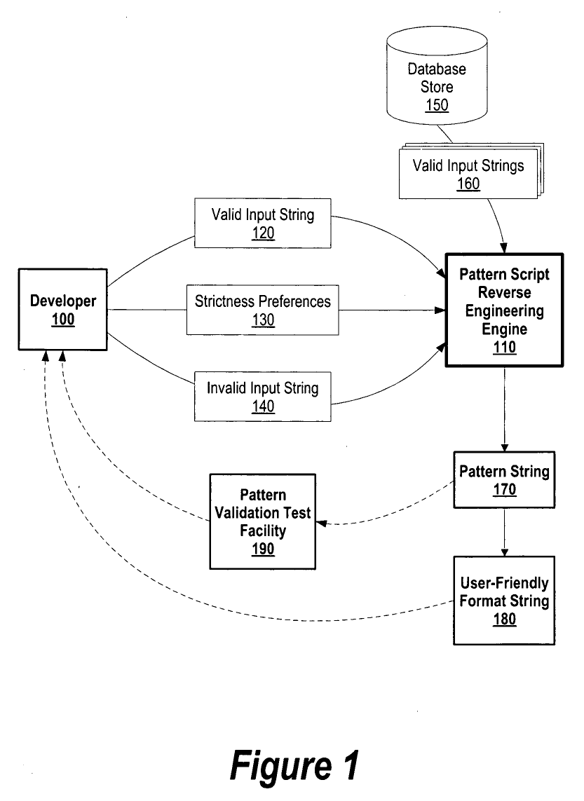

FIG. 1 is a diagram showing a pattern script reverse engineering engine generating a pattern string and a user-friendly format string using a valid input string. Developer 100 provides valid input strings, such as valid input string 120, to pattern script reverse engineering engine 110, whereby pattern script reverse engineering engine 110 generates pattern string 170. Pattern string 170 is used to validate future input strings that are received by a particular form. Pattern script reverse engineering engine 110 may operate in a single mode or a multi-mode. In a single mode, pattern script reverse engineering engine 110 uses a single input string to generate a pattern string. In a multi-mode, pattern script reverse engineering engine 110 uses multiple input strings, typically from a database, to generate a pattern string.

Developer 100 identifies and provides strictness preferences 130 to pattern script reverse engineering engine 110. Strictness preferences 130 determine what type of pattern element to generate for each valid input string element. For example, an input string of “abcd” may be converted to \w{4}, \w{0,4}, or \w*, each providing varying levels of flexibility in which to filter subsequent input strings. In a high strictness preference setting, pattern script reverse engineering engine 110 may generate a pattern that constricts the input for a set of word characters to match the same number of characters, or may even require an input string with the exact characters explicitly. In a low strictness preference setting, pattern script reverse engineering engine 110 may generate a pattern string such that any number of word characters may be entered in a certain stanza of the pattern or a range of characters that are based upon a valid input range. Pattern script reverse engineering engine 110 uses strictness preferences 130 in either single mode or multi-mode.

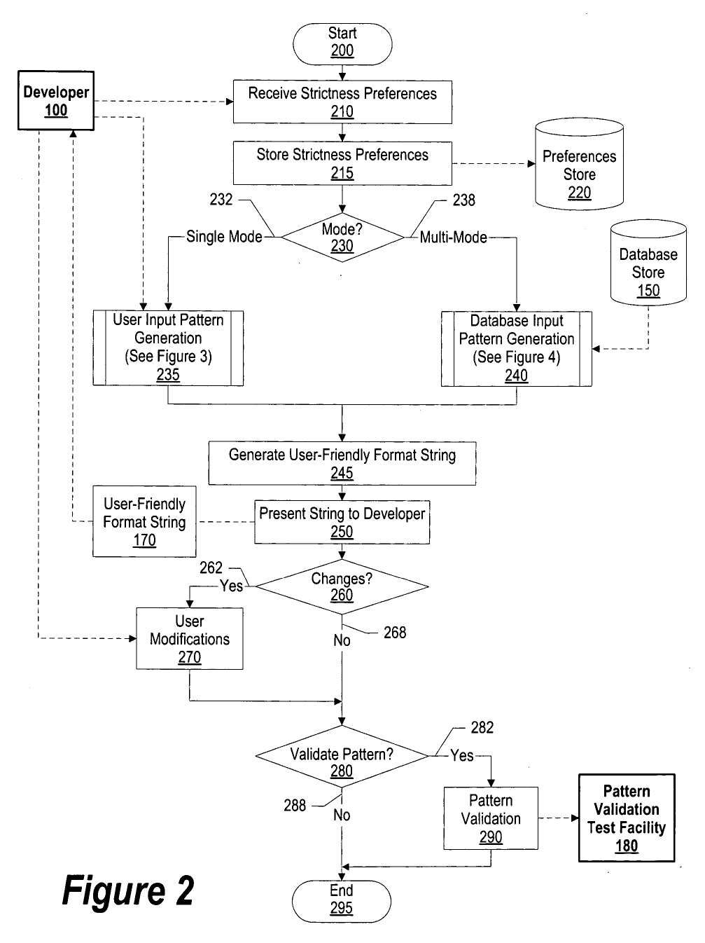

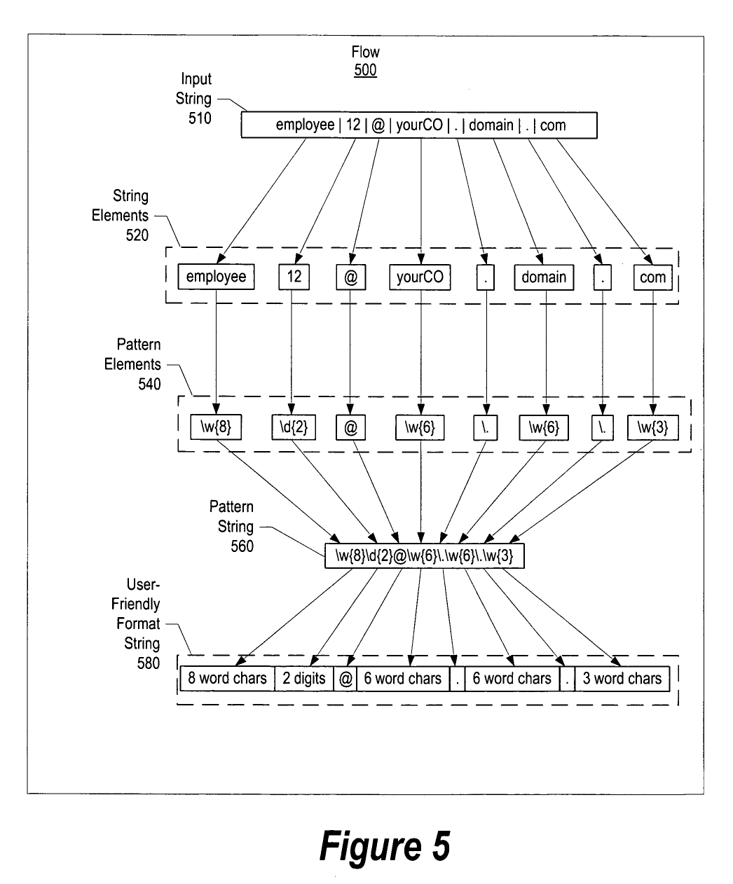

In single mode, developer 100 sends valid input string 120 to pattern script reverse engineering engine 110. Pattern script reverse engineering engine 110 uses strictness preferences 130 to generate pattern string 170 based upon valid input string 120, and then uses pattern string 170 in order to generate user-friendly format string 180. User-friendly format string 180 is in a format such that developer 100 is able to analyze the string and determine whether to make adjustments, such as making user-friendly format string 180 more flexible to accept particular input strings (see FIGS. 2, 5, and corresponding text for further details regarding user-friendly format strings).

In one embodiment, developer 100 may test pattern string 170 by providing invalid input string 140 to pattern script reverse engineering engine 110. In this embodiment, pattern script reverse engineering engine 110 checks invalid input string 140 against pattern string 170. In addition, developer 100 may wish to validate pattern string 170 using pattern validation test facility 180, which tests pattern string 170 by providing it with valid and invalid input strings.

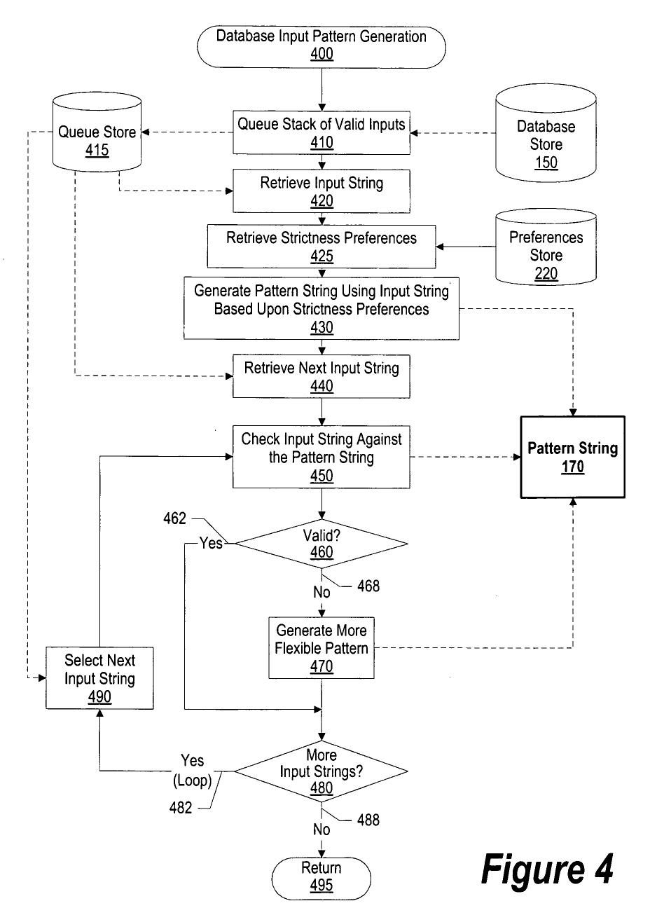

In multi-mode, pattern script reverse engineering engine 110 retrieves valid input strings 160 from database store 150, and queues each of the valid input strings that is included in valid input strings 160. Pattern script reverse engineering engine 110 selects one of the input strings and generates a pattern string based upon strictness preferences 130. Once a pattern string is generated, pattern script reverse engineering engine 110 uses another queued input string to validate the generated pattern string. Based upon the results, pattern script reverse engineering engine 110 may modify the pattern string in order to accommodate varying types of input strings (see FIG. 4 and corresponding text for further details regarding multi-mode pattern string modifications). Once pattern script reverse engineering engine 110 has used each of the queued input strings to validate the pattern string, pattern script reverse engineering engine 110 generates user-friendly format string 180, which developer 100 may analyze.

FIG. 2 is a high-level flowchart showing steps taken in using strictness preferences to tailor a pattern string and a user-friendly format string. Processing commences at 200, whereupon processing receives strictness preferences from developer 100 at step 210. Developer 100 is the same as that shown in FIG. 1. A pattern engine uses the strictness preferences in order to determine what type of pattern element to generate for each type of input string element. For example, an input string of “abcd” could be converted to \w{4}, \w{0,4}, or \w*, each providing varying levels of flexibility in which to filter input strings. In a high strictness preference setting, a pattern engine may generate a pattern that constricts the input for a set of word characters to match the same number of characters, or may even require an input string with the exact characters explicitly. In a low strictness preference setting, a pattern may be generated such that any number of word characters may be entered in a certain stanza of the pattern or a range of characters that are keyed off a valid input range. Processing stores the strictness preferences in preferences store 220 at step 215. Preferences store 220 may be stored on a nonvolatile storage area, such as a computer hard drive.

A determination is made as to whether user-friendly format strings should be generated using a single mode or a multi-mode (decision 230). In a single mode (e.g. user-input mode), processing uses a single input string to generate a pattern string based upon particular strictness preferences. In a multi-mode (e.g. database-input mode), processing uses an input string to generate a pattern string based upon particular strictness preferences, and then refines the pattern string (e.g. adjusts constraints) using other valid input strings.

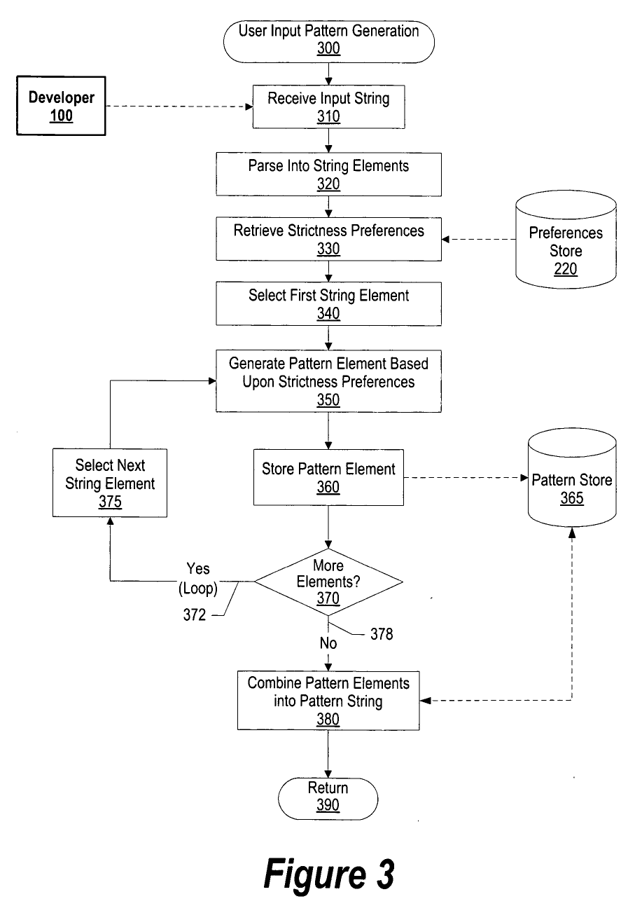

If the user-friendly format string should be generated using a single mode, decision 230 branches to “Single Mode” branch 232 whereupon processing generates a pattern string using an input string it receives from developer 100 (pre-defined process block 235, see FIG. 3 and corresponding text for further details). On the other hand, if the user-friendly format string should be generated using a multi-mode, decision 230 branches to “Multi-Mode” branch 238 whereupon processing generates a pattern string using input strings it receives from database store 150 (pre-defined process block 240, see FIG. 4 and corresponding text for further details). Database store 150 is the same as that shown in FIG. 1.

Once a pattern string is generated from either the single mode or the multi-mode, processing generates a user-friendly format string using the pattern string (step 245). A user-friendly format string converts the pattern string into a format that is easily understandable by developer 100. For example, if a pattern string is “\w{8}\d{2}@\w{6}\.\w{6}\.\w{3},” a corresponding user-friendly format string is generated as follows:

| | | | | | | | |
|---|---|---|---|---|---|---|---|
| 8 word | 2 digits | @ | 6 word chars | . | 6 word chars | . | 3 word chars |
| chars | | | | | | | |

At step 250, processing presents the user-friendly format string to developer 100. A determination is made as to whether the developer wishes to make changes, such as modifying the corresponding pattern string to make it more or less constricting (decision 260). If the developer does not wish to make changes to the pattern string, decision 260 branches to “No” branch 268 bypassing developer modification steps.

On the other hand, if developer 100 wishes to modify the pattern string, decision 260 branches to “Yes” branch 262 whereupon processing receives modifications from developer 100 and modifies the pattern string and the user-friendly format string (step 270). In one embodiment, a developer may wish to modify the user-friendly format string without repeating the generation process. In this embodiment, the developer may modify the user-friendly format string appropriately. For example, a developer may wish to combine the first two components of a user-friendly format string into one component (e.g. “8 word characters” and “2 digits”). In this example, the developer may change the first two components into “10 alphanumeric characters” or even “alphanumeric characters*” to accept any number of alphanumeric characters. Thus, the user, without having to understand the underlying pattern syntax, is able to easily modify a user-friendly format string using the same user-friendly semantics in order to arrive at a pattern that meets the user's requirements.

A determination is made as to whether the developer wishes to use pattern validation test facility 180 to validate the pattern string (decision 280). If the developer wishes to validate the pattern string using pattern validation test facility, decision 280 branches to “Yes” branch 282 whereupon processing uses pattern validation test facility 190 to validate the pattern string (step 290). On the other hand, if the developer does not wish to validate the pattern, decision 280 branches to “No” branch 288, bypassing pattern string validation steps. Pattern validation test facility 190 is the same as that shown in FIG. 1. Processing ends at 295.

FIG. 3 is a flowchart showing steps taken in receiving an input string from a user and generating a pattern string based upon particular strictness preferences. In user input mode, processing uses an input string to generate a pattern string based upon particular strictness preferences. In database-input mode, which is discussed in FIG. 4 below, processing generates a pattern string based upon particular strictness preferences, and then refines the pattern string (e.g. adjusts constraints) using valid input strings.

User input pattern generation processing commences at 300, whereupon processing receives an input string from developer 100 at step 310. Developer 100 is the same as that shown in FIG. 1. At step 320, processing parses the input string into a plurality of string elements. For example, if the input string is

“employee |12 |@|yourCO |. |domain |. |com”

then processing parses the input string into eight string elements, which are as follows:

element 1: employee

element 2: 12

element 3: @

element 4: yourCO

element 5: .

element 6: domain

element 7: .

element 8: com

Processing retrieves strictness preferences from preferences store 220 at step 330. A user may specify a strictness preference, which identifies a generated user-friendly format string's flexibility to accept input strings. A pattern engine uses the strictness preferences in order to determine what type of pattern element to generate for each type of input string element. For example, an input string of “abcd” may be converted to \w{4}, \w{0,4}, or \w*, each providing varying levels of flexibility in filtering input strings. In a high strictness preference setting, a pattern engine may generate a pattern that constricts the input for a set of word characters to match the same number of characters, or may require an input string to explicitly match exact characters. In a low strictness preference setting, a pattern may be generated such that any number of word characters may be entered in a certain stanza of the pattern or a range of characters that are keyed off a valid input range. Preferences store 220 may be stored on a nonvolatile storage area, such as a computer hard drive.

Processing selects a first string element from the parsed input string at step 340. At step 350, processing generates a pattern element for the string element that corresponds with the strictness preferences. Processing stores the pattern element in pattern store 365 at step 360. Pattern store 365 may be stored on a nonvolatile storage area, such as a computer hard drive.

A determination is made as to whether there are more input string elements to process that were parsed from the input string (decision 370). If there are more string elements to process, decision 370 branches to “Yes” branch 372 which loops back to select (step 375) and process the next input string element. This looping continues until there are no more input string elements to process, at which point decision 370 branches to “No” branch 378.

At step 380, processing combines the pattern elements that are stored in pattern store 365 into a pattern string. The pattern string is then formatted into a user-friendly format string, which is presented to the user (see FIGS. 2, 5, and corresponding text for further details regarding user-friendly format string details). Processing returns at 390.

FIG. 4 is a flowchart showing steps taken in receiving a plurality of input strings from a database and customizing a pattern string based upon one or more valid input strings. In database-input mode, processing generates a pattern string based upon a particular strictness preference, and then refines the pattern string (e.g. adjusts constraints) using valid input strings. In user input mode, which is discussed in FIG. 3 above, processing uses an input string to generate a pattern string based upon a particular strictness preference.

Database input pattern generation processing commences at 400, whereupon processing retrieves valid input strings from database store 150, and queues the valid input strings in queue store 415. Database store 150 is the same as that shown in FIG. 1. Queue store 415 may be stored on a nonvolatile storage area, such as a computer hard drive.

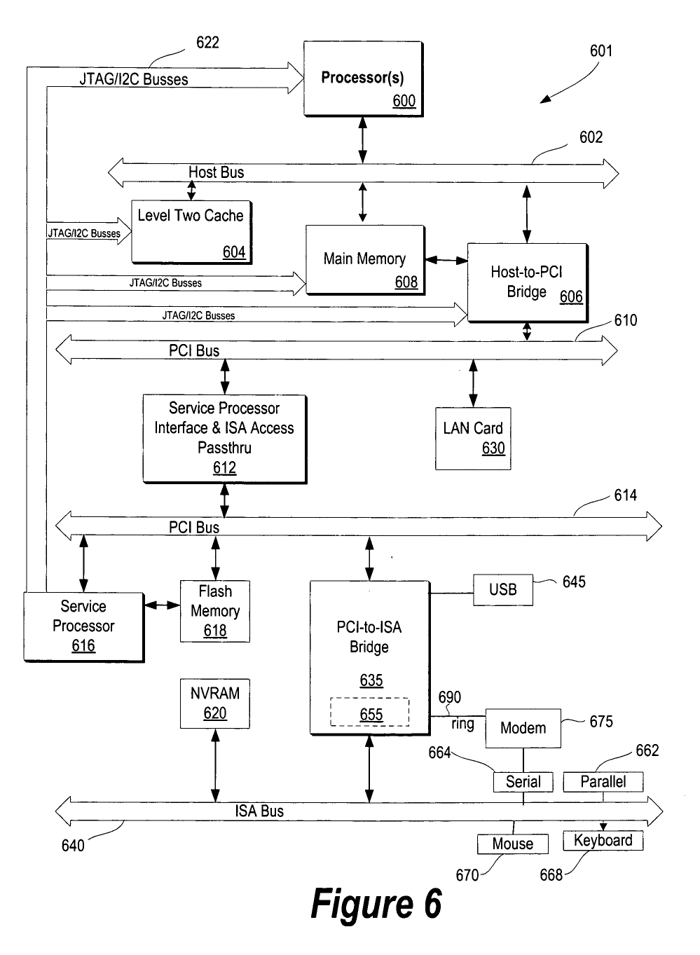

At step 420, processing retrieves the first input string from queue store 415. In order to determine how “precise” to define an input pattern, processing uses a strictness preference, which it retrieves from preferences store 220 at step 425. Preferences store 220 is the same as that shown in FIG. 2. Using the strictness preference and the retrieved input string, processing generates pattern string 170 by parsing the input string into string elements, generating a pattern string for each string element, and combining the pattern strings to create pattern string 170 (see FIGS. 3, 6, and corresponding text for further details regarding incremental pattern string generation steps). Pattern string 170 is the same as that shown in FIG. 1.

Once processing generates pattern string 170, processing proceeds through a series of steps (discussed below) which use the remaining queued input strings that are stored in queue store 415 in order to determine whether pattern string 170 should be more “flexible.” At step 440, processing retrieves the first of the remaining input strings from queue store 415, and at step 450, processing checks the input string against pattern string 170.

A determination is made as to whether the input string is valid when it is checked against pattern string 170 (decision 460). Since each input string included in queue store 415 is a valid input string, each input string should return a valid result. If it does not, then pattern string 170 is too constrictive and should be adjusted. If the input string did not return a valid result when it was checked against pattern string 170, decision 460 branches to “No” branch 468 whereupon processing modifies pattern string 170 to be more flexible (step 470). For example, pattern string 170 may have specified that five particular characters be present in an input string, and processing may modify pattern string 170 to accept any five characters be present in the input string. On the other hand, if the input string does return a valid result when checked against pattern string 170, decision 460 branches to “Yes” branch 462 bypassing pattern string modification steps.

A determination is made as to whether there are more input strings that are queued in queue store 415 (decision 480). If there are more input strings in queue, decision 480 branches to “Yes” branch 482 which loops back to select (step 490) and process the next input string. This looping continues until there are no more input strings to process, at which point decision 480 branches to “No” branch 488 whereupon processing returns at 495.

FIG. 5 is a diagram flow showing various sequences of events in using an input string to generate a user-friendly format string. Flow 500 includes input string 510, string elements 520, pattern elements 540, pattern string 560, and user-friendly format string 580. Input string 510 includes eight separate elements, in which a pattern engine parses into string elements 520.

The pattern engine uses strictness preferences to reverse engineer each of string elements 520 and, in turn, generate pattern elements 540. Pattern elements 540 include a pattern element for each of the string elements included in string elements 520. The strictness preferences inform the pattern generator as to how much to constrain a pattern element. For example, an input string of “abcd” may be converted to \w{4}, \w{0,4}, or \w*, each providing varying levels of flexibility in which to filter input strings. In a high strictness preference setting, a pattern engine may generate a pattern that constricts the input for a set of word characters to match the same number of characters, or may even require an input string to explicitly match exact characters. In a low strictness preference setting, a pattern may be generated such that any number of word characters may be entered in a certain stanza of the pattern or a range of characters that are keyed off a valid input range.

Once a pattern engine generates individual pattern elements for each individual string element, the pattern engine combines the pattern elements into a pattern string, such as pattern string 560. Pattern string 560 is a pattern representation of input string 510 that is based upon particular strictness preferences. The pattern engine converts pattern string 560 into user-friendly format string 580 such that a user is able to analyze the user-friendly format string and determine whether to make adjustments.

In one embodiment, a user may wish to modify user-friendly format string 580 without repeating the generation process. In this embodiment, the user may modify user-friendly format string 580 appropriately. For example, a user may wish to combine the first two components of user-friendly format string 580 into one component (i.e. “8 word characters” and “2 digits”). In this example, the user may change the first two components into “10 alphanumeric characters” or even “alphanumeric characters*” to accept any number of alphanumeric characters. Thus, the user, without having to understand the underlying pattern syntax, is able to easily modify a user-friendly format string using the same user-friendly semantics in order to arrive at a pattern that meets the user's requirements.

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving an input string that includes a plurality of string elements;
creating a pattern element for each of the plurality of string elements, resulting in a plurality of pattern elements;
combining the plurality of pattern elements into a pattern string; and
validating subsequent input strings using the pattern string.

2. The method of claim 1 further comprising:
receiving a strictness preference, whereby the strictness preference is used to determine how much constriction is placed upon each of the plurality of pattern elements during the creating.

3. The method of claim 2 further comprising:
retrieving a queued input string;
comparing the queued input string with the pattern string; and
modifying the pattern string based upon comparing, whereby the modifying includes reducing the constriction of the pattern string.

4. The method of claim 1 further comprising:
receiving an invalid input string;
comparing the invalid input string with the pattern string; and
invalidating the invalid input string in response to the comparing.

5. The method of claim 1 further comprising:
generating a user-friendly format string based upon the pattern string; and
presenting the user-friendly format string to a user.

6. The method of claim 6 further comprising:
receiving one or more changes from the user; and
modifying the user-friendly format string and the pattern string based upon the received changes.

7. The method of claim 1 wherein the input string and the pattern string correspond to an xForms format.

8. A program product comprising:
computer operable medium having computer readable code, the computer readable code being effective to:
receive an input string that includes a plurality of string elements;
create a pattern element for each of the plurality of string elements, resulting in a plurality of pattern elements;
combine the plurality of pattern elements into a pattern string; and
validate subsequent input strings using the pattern string.

9. The program product of claim 8 wherein the computer readable code is further effective to:
receive a strictness preference, whereby the strictness preference is used to determine how much constriction is placed upon each of the plurality of pattern elements during the creating.

10. The program product of claim 9 wherein the computer readable code is further effective to:
retrieve a queued input string;
compare the queued input string with the pattern string; and
modify the pattern string based upon comparing, whereby the modifying includes reducing the constriction of the pattern string.

11. The program product of claim 8 wherein the computer readable code is further effective to:
receive an invalid input string;
compare the invalid input string with the pattern string; and
invalidate the invalid input string in response to the comparing.

12. The program product of claim 8 wherein the computer readable code is further effective to:
generate a user-friendly format string based upon the pattern string; and
present the user-friendly format string to a user.

13. The program product of claim 12 wherein the computer readable code is further effective to:
receive one or more changes from the user; and
modify the user-friendly format string and the pattern string based upon the received changes.

14. The program product of claim 8 wherein the input string and the pattern string correspond to an xForms format.

15. An information handling system comprising:
one or more processors;
a memory accessible by the processors;
one or more nonvolatile storage devices accessible by the processors; and
a pattern string generation tool for generating a pattern string, the pattern string generation tool comprising computer readable code effective to:
retrieve an input string that includes a plurality of string elements from one of the nonvolatile storage devices;
create a pattern element for each of the plurality of string elements, resulting in a plurality of pattern elements;
combine the plurality of pattern elements into the pattern string; and
validate subsequent input strings that are retrieved from one of the nonvolatile storage devices using the pattern string.

16. The information handling system of claim 15 wherein the computer readable code is further effective to:
receive a strictness preference from one of the nonvolatile storage devices, whereby the strictness preference is used to determine how much constriction is placed upon each of the plurality of pattern elements during the creating.

17. The information handling system of claim 16 wherein the computer readable code is further effective to:
retrieve a queued input string from one of the nonvolatile storage devices;
compare the queued input string with the pattern string; and
modify the pattern string based upon comparing, whereby the modifying includes reducing the constriction of the pattern string.

18. The information handling system of claim 15 wherein the computer readable code is further effective to:
retrieve an invalid input string from one of the nonvolatile storage devices;
compare the invalid input string with the pattern string; and
invalidate the invalid input string in response to the comparing.

19. The information handling system of claim 15 wherein the computer readable code is further effective to:
generate a user-friendly format string based upon the pattern string; and
present the user-friendly format string to a user.

20. The information handling system of claim 19 wherein the computer readable code is further effective to:
receive one or more changes from the user; and
modify the user-friendly format string and the pattern string based upon the received changes.

21. A computer-implemented method comprising:
receiving an input string that includes a plurality of string elements;
receiving a strictness preference, whereby the strictness preference is used to determine how much constriction is placed upon each of the plurality of pattern elements;
creating a pattern element for each of the plurality of string elements using the strictness preference, resulting in a plurality of pattern elements;
combining the plurality of pattern elements into a pattern string; and
validating subsequent input strings using the pattern string.

22. A computer-implemented method comprising:
receiving an input string that includes a plurality of string elements;
creating a pattern element for each of the plurality of string elements, resulting in a plurality of pattern elements;
combining the plurality of pattern elements into a pattern string;
generating a user-friendly format string based upon the pattern string;
presenting the user-friendly format string to a user;
receiving one or more changes from the user;
modifying the user-friendly format string and the pattern string based upon the received changes; and
validating subsequent input strings using the modified pattern string.

23. A program product comprising:
computer operable medium having computer readable code, the computer readable code being effective to:
receive an input string that includes a plurality of string elements;
receive a strictness preference, whereby the strictness preference is used to determine how much constriction is placed upon each of the plurality of pattern elements;
create a pattern element for each of the plurality of string elements using the strictness preference, resulting in a plurality of pattern elements;
combine the plurality of pattern elements into a pattern string; and
validate subsequent input strings using the pattern string.

24. A program product comprising:
computer operable medium having computer readable code, the computer readable code being effective to:
receive an input string that includes a plurality of string elements;
create a pattern element for each of the plurality of string elements, resulting in a plurality of pattern elements;
combine the plurality of pattern elements into a pattern string;
generate a user-friendly format string based upon the pattern string;
present the user-friendly format string to a user;
receive one or more changes from the user;
modify the user-friendly format string and the pattern string based upon the received changes; and
validate subsequent input strings using the modified pattern string.

25. An information handling system comprising:
one or more processors;
a memory accessible by the processors;
one or more nonvolatile storage devices accessible by the processors; and
a pattern string generation tool for generating a pattern string, the pattern string generation tool comprising computer readable code effective to:
retrieve an input string that includes a plurality of string elements from one of the nonvolatile storage devices;
retrieve a strictness preference from one of the nonvolatile storage devices, whereby the strictness preference is used to determine how much constriction is placed upon each of the plurality of pattern elements;
create a pattern element for each of the plurality of string elements using the strictness preference, resulting in a plurality of pattern elements;
combine the plurality of pattern elements into a pattern string; and
validate subsequent input strings using the pattern string.
